(19) United States
(12) Patent Application Publication
(10) Pub. No.: US 2025/0118905 A1
(43) Pub. Date: Apr. 10, 2025

(54) RECONFIGURABLE ANTENNA

(71) Applicant: Commissariat à l'Energie Atomique et aux Energies Alternatives, PARIS (FR)

(72) Inventors: Antonio CLEMENTE, GRENOBLE (FR); José Luis GONZALEZ JIMENEZ, GRENOBLE (FR)

(21) Appl. No.: 18/906,141

(22) Filed: Oct. 3, 2024

(30) Foreign Application Priority Data
Oct. 5, 2023 (FR) 2310682

(51) Int. Cl. H01Q 23/00; H01Q 21/28

(52) U.S. Cl. CPC H01Q 23/00; H01Q 21/28

(57) ABSTRACT

The present description concerns an antenna (100) comprising an amplifier array (101) comprising a plurality of first elementary cells (103); and a transmitarray (105) comprising a plurality of second elementary cells (107), wherein the amplifier array (101) is configured to irradiate, or to be irradiated by, the transmitarray (105), the amplifier array (101) being separated from the transmitarray (105) by a distance equal, to within 20%, to a central transmission and/or reception wavelength of the antenna (100).

### FIELD

The present disclosure generally concerns electronic devices, more particularly reconfigurable antennas.

### BACKGROUND

As compared with conventional antennas, reconfigurable antennas can have an improved gain and provide access to additional functionalities, for example of electronic beam steering or of multiple, pencil, or shaped beam emission. This benefits the development of many applications, such as radar systems, detection systems, and communication systems from the C-band (approximately from 4 to 8 GHz) to the D-band (approximately from 110 to 170 GHz). The use of reconfigurable antennas is further envisaged in a frequency band located around 300 GHz.

Multiple fields of application are likely to take advantage of reconfigurable antennas, among which:
motor vehicle driver assistance radars, for example, for active security purposes;
very-high-resolution imaging and monitoring systems;
very-high-speed millimeter-wave communication systems, for example for inter- or intra-building communications in a home or building automation environment;
antennas for space applications, for example Ka-band LEO (Low Earth Orbit) ground-to-satellite telemetry links, reflector antennas dedicated to satellite communications with a reconfigurable primary source, SOTM (Satellite On The Move) systems, Internet access devices or systems, television broadcasting devices or systems, etc.; and
point-to-point and point-to-multipoint communication systems, such as metropolitan area networks, fronthaul and backhaul systems for cellular networks, radio accesses for 5G mobile networks, etc.

Among existing high-gain antennas, reflector antennas have in particular been provided. These antennas are however complex and expensive to build since reflectors require, in particular for high-frequency applications, a very precise curvature. Further, motors are used to steer the beam in the desired direction. Phased-array antennas have been provided to allow an electronic control of the beam. However, these antennas turn out being expensive to be developed and produced, in particular due to the fact that they comprise amplification modules aiming at compensating for losses induced by phase-shift circuits.

Other reconfigurable beam steering and/or beam-forming antennas have further been provided. Among these antennas, there in particular exist transmitarray antennas, also known as discrete lens antennas. Existing transmitarray antennas generally comprise a radiating panel comprising reconfigurable elementary cells, or transmitter cells. Each elementary cell of the radiating panel comprises a first antenna element irradiated by an electromagnetic field emitted by one or a plurality of focal sources, a second antenna element transmitting a modified signal to the outside of the antenna, and a coupling element between the first and second antenna elements. The elementary cells are intended to control an electromagnetic field distribution in the vicinity of a radiating aperture of the antenna, thus enabling to produce one or a plurality of beams in a given direction or to synthesize a beam with a defined pattern. In an ideal case, each elementary cell is capable of compensating for any path difference between the focal source(s) and the radiating aperture. In practice, for the sake of simplification of the antenna, the elementary cells can only compensate for a limited number of phase states, for example 2N phase states, with N a positive integer, in the case of a compensation with an N-bit phase quantization. A same transmitarray can alternate between transmit and receive phases, provided for it to be free of non-reciprocal elements such as amplifiers or attenuators. Otherwise, the transmitarray can only operate in transmit or in receive mode.

Transmitarray antennas however suffer from various disadvantages. In particular, existing transmitarray antennas have a relatively large thickness, dictated by the need to keep the focal source(s) away from the transmitarray.

### SUMMARY

It would be desirable to overcome all or part of the disadvantages of existing reconfigurable antennas. There more particularly exists a need for reconfigurable antennas having an improved performance, a decreased power consumption, and a smaller bulk than existing reconfigurable antennas, for example to meet the needs of applications such as satellite communications (SATCOM).

For this purpose, an embodiment provides an antenna comprising:
an amplifier array comprising a plurality of first elementary cells; and
a transmitarray comprising a plurality of second elementary cells, wherein the amplifier array is configured to irradiate, or to be irradiated by, the transmitarray, the amplifier array being separated from the transmitarray by a distance equal, to within 20%, to a central transmission and/or reception wavelength of the antenna.

According to an embodiment, the distance separating the amplifier array from the transmitarray is equal, to within 10%, to the central transmission and/or reception wavelength of the antenna.

According to an embodiment, each first elementary cell comprises a first antenna element located in front of the transmitarray.

According to an embodiment, each first elementary cell further comprises at least one amplifier connected to the first antenna element.

According to an embodiment, each first elementary cell comprises:
a first amplifier, preferably a power amplifier, intended to amplify a signal transmitted by the antenna;
a second amplifier, preferably a low-noise amplifier, intended to amplify a signal received by the antenna; and -a switch configured to enable the first or the second amplifier as a function of a control signal.

According to an embodiment, each first elementary cell is connected to a radio frequency signal transceiver circuit.

According to an embodiment, the antenna further comprises at least one source configured to irradiate, or to be irradiated by, the amplifier array.

According to an embodiment, said at least one source is connected to a radio frequency signal transceiver circuit.

According to an embodiment, each first cell further comprises a second antenna element located in front of said at least one source.

According to an embodiment, said at least one source is a single horn antenna.

According to an embodiment, the antenna comprises fewer first elementary cells than second elementary cells, preferably four times fewer first elementary cells than second elementary cells.

According to an embodiment, each second elementary cell comprises third and fourth antenna elements coupled by a phase-shift circuit.

According to an embodiment, the amplifier array is devoid of phase-shift circuits.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a simplified and partial side view of a reconfigurable antenna according to an embodiment;

FIG. 2 is a detail view of a portion of the antenna of FIG. 1;

FIG. 3 is a simplified and partial top view of the antenna of FIG. 1 according to an embodiment;

FIG. 4 is a simplified and partial side view of a reconfigurable antenna according to an embodiment; and

FIG. 5 is a detail view of a portion of the antenna of FIG. 4.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the methods of manufacturing the described transmitarrays will not be detailed, the forming of the described structures being within the abilities of those skilled in the art based on the indications of the present disclosure, for example by implementing conventional printed circuit board manufacturing techniques.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

In the following description, the qualifiers “insulating” and “conductive” respectively mean, unless specified otherwise, electrically insulating and electrically conductive.

In the following description, the expression transmission, or reception “central wavelength” of an antenna designates a wavelength corresponding to an operating frequency of the antenna, that is, a frequency predominantly used to communicate by means of the antenna. The central wavelength corresponds, for example, substantially to the frequency for which the signal transmitted or received by the antenna has a maximum intensity.

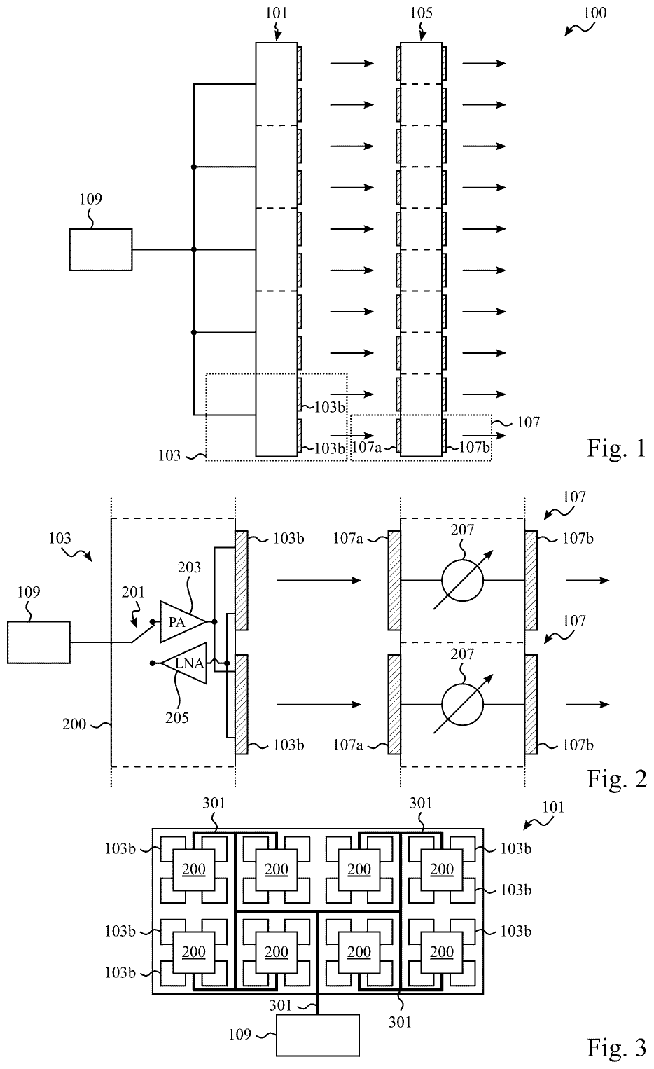

FIG. 1 is a simplified and partial side view of a reconfigurable antenna 100 according to an embodiment.

According to this embodiment, reconfigurable antenna 100 comprises an amplifier array 101 comprising a plurality of elementary cells 103, and a transmitarray 105 comprising a plurality of elementary cells 107. According to an embodiment, the amplifier array is configured to irradiate or to be irradiated by transmitarray 105. Amplifier array 101 is positioned in a near-field region of transmitarray 105.

The elementary cells 103 of amplifier array 101 are for example arranged in an array of rows and columns. Further, the elementary cells 103 are for example substantially located in a same plane, amplifier array 101 being in this case of planar type. In the illustrated example, each elementary cell 103 comprises a plurality of antenna elements 103b, for example four antenna elements 103b (only two antenna elements 103b of each elementary cell 103 are shown in FIG. 1), located on the side of a surface of amplifier array 101 facing transmitarray 105. As an example, amplifier array 101 is built in planar technology, for example on a printed circuit board.

Similarly, the elementary cells 107 of transmitarray 105 are arranged for example in an array of rows and columns. Further, the elementary cells 107 are for example substantially located in the same plane, for example a plane substantially parallel to the plane of amplifier array 101. According to an embodiment, amplifier array 101 is separated from transmitarray 105 by a distance equal, to within 20%, to a central transmission and/or reception wavelength of antenna 100. The distance separating amplifier array 101 from transmitarray 105 is, for example, equal, to within 10%, to the central transmission and/or reception wavelength of antenna 100. Each elementary cell 107 comprises, for example, a first antenna element 107a, located on the side of a first surface of transmitarray 105 arranged in front of amplifier array 101, and a second antenna element 107b, located on the side of a second surface of transmitarray 105 opposite to the first surface. The second surface of transmitarray 105 for example faces a transmitting medium, or external medium, of antenna 100.

In the shown example, reconfigurable antenna 100 comprises a number of elementary cells 103 smaller than the number of elementary cells 107. As an example, reconfigurable antenna 100 comprises four times fewer elementary cells 103 than elementary cells 107. This example is however not limiting, and reconfigurable antenna 100 may, as a variant, comprise, for example, nine or sixteen times fewer elementary cells 103 than elementary cells 107.

In the illustrated example, amplifier array 101 comprises a number of antenna elements 103b equal to the number of first antenna elements 107a of transmitarray 105, each antenna element 103b of amplifier array 101 being for example located in front of one of the first antenna elements 107a of transmitarray 105. However, this example is not limiting and amplifier array 101 may, as a variant, comprise a number of antenna elements 103b smaller than, or greater than, the number of first antenna elements 107a of transmitarray 105.

Transmitarray 105 for example has a surface area equal, to within 10%, to the surface area of the amplifier array 101 located in front of it.

Although only five elementary cells 103 and ten elementary cells 107 have been shown in FIG. 1, reconfigurable antenna 100 may of course comprise numbers of elementary cells 103 and of elementary cells 107 different from those shown, for example several tens, several hundreds, or several thousands of elementary cells 103 and of elementary cells 107.

In the illustrated example, the elementary cells 103 of amplifier array 101 are connected to a circuit 109. Circuit 109 is, for example, a radio frequency signal transceiver circuit, for example a circuit intended to generate signals to be transmitted by reconfigurable antenna 100 and/or to process signals received by reconfigurable antenna 100. This example is however not limiting, and circuit 109 may also implement additional functions such as functions of analog-to-digital conversion, filtering, impedance matching, interference elimination, etc. As an example, elementary cells 103 are connected to the circuit 109 by conductive tracks and/or conductive vias of the printed circuit board inside and on top of which amplifier array 101 is formed.

FIG. 1 more particularly illustrates a case in which reconfigurable antenna 100 operates in transmit mode. In this case, each elementary cell 103 of amplifier array 101 is capable of receiving a signal from circuit 109 and of transmitting an electromagnetic radiation, corresponding to the received signal, from its antenna elements 103b towards transmitarray 105. Each elementary cell 107 of transmitarray 105 is capable of receiving, on its first antenna element 107a, the electromagnetic radiation emitted by the elementary cells 103 of amplifier array 101 and of transmitting back this radiation from its second antenna element 107b, for example by introducing a known phase shift ø.

The characteristics of the near- or far-field radiation generated by antenna 100, in particular its shape (or pattern), its intensity, and its maximum emission direction (or pointing direction), depend on the values of the phase shifts respectively introduced by the different elementary cells 107 of transmitarray 105. In the shown example, the shape of the radiation, or the radiation pattern, of antenna 100 only depends on the configuration of the cells 107 of transmitarray 105. In this example, amplifier array 101 has an amplification function only. In particular, amplifier array 101 acts neither on the shape, nor on the pointing direction of antenna 100.

Although this has not been shown, reconfigurable antenna 100 may, as a variant, operate in receive mode. In this case, each elementary cell 107 of transmitarray 105 is capable of receiving an electromagnetic radiation originating from the outer environment on its second antenna element 107b and of transmitting back this radiation from its first antenna element 107a, towards amplifier array 101, with phase shift ¢. Each elementary cell 103 of amplifier array 101 is capable of receiving, on its antenna elements 103b, the electromagnetic radiation emitted by the elementary cells 107 of transmitarray 105 and of supplying, to circuit 109, a signal corresponding to the received electromagnetic radiation.

The transmitarray 105 of antenna 100 is said to be reconfigurable when the elementary cells 107 are electronically controllable, individually, to modify their phase shift value ¢ and/or their amplitude, which enables to dynamically modify the characteristics of the radiation generated by the antenna, and in particular to modify its pointing direction without mechanically moving the antenna or part of the antenna by means of a motorized element.

FIG. 2 is a detail view of a portion of the reconfigurable antenna 100 of FIG. 1. FIG. 2 more specifically shows one elementary cell 103 and two elementary cells 107 located opposite one another.

In the shown example, elementary cell 103 comprises an amplification circuit 200 comprising a switch 201, for example a single-pole double-throw (SPDT) switch. In this example, switch 201 more specifically comprises an input connected to circuit 109, a first output connected to an input of a first amplifier 203 (PA) of amplification circuit 200, and a second output connected to an output of a second amplifier 205 (LNA) of amplification circuit 200. Switch 201 for example receives a control signal for connecting its input to its first output, when reconfigurable antenna 100 is used in transmit mode, and to its second output, when reconfigurable antenna 100 is used in receive mode.

The amplifier 203 of elementary cell 103 is for example intended to amplify a signal transmitted by antenna 100. As an example, amplifier 203 is a power amplifier, for example a Class-A linear amplifier in CMOS (Complementary Metal-Oxide-Semiconductor) SOI (Silicon On Insulator) technology, for example of the type described in the article by A. Hamani, A. Siligaris, B. Blampey and J. L. G. Jimenez entitled “167-GHz and 155-GHz High Gain D-band Power Amplifiers in CMOS SOI 45”. Hamani, A. Siligaris, B. Blampey and J. L. G. Jimenez entitled “167-GHz and 155-GHz High Gain D-band Power Amplifiers in CMOS SOI 45-nm Technology” from the fifteenth European Microwave Integrated Circuits Conference (EuMIC) in Utrecht, the Netherlands, 2021, pp. 261-264.

The amplifier 205 of elementary cell 103 is for example intended to amplify a signal received by antenna 100. As an example, amplifier 205 is a low-noise amplifier (LNA). This enables to optimize the noise figure of elementary cell 103 when it is used in receive mode. As an example, amplifier 205 comprises a class “AB” amplifier for example comprising one or two operating stages. Amplifier 205 for example has an electrical power in the range from 10 to 20 mW.

In the shown example, the amplifier 203 of elementary cell 103 comprises an output connected to each antenna element 103b of the cell. Further, in this example, amplifier 205 comprises an input connected to each antenna element 103b of the cell, for example to a region of each antenna element 103b different from a region to which the output terminal of amplifier 203 is connected. As an example, each antenna element 103b is a patch antenna comprising, for example, a conductive plane of rectangular or square shape in which a U-shaped slot is formed.

In the illustrated example, each elementary cell 107 comprises a phase-shift circuit 207, having a first terminal connected to the antenna element 107a located in front of one of the antenna elements 103b of elementary cell 103, and having a second terminal connected to the antenna element 107b facing the outer environment. Phase-shift circuit 207 is configured, for example, to apply a phase shift ϕ between the signal received by antenna element 107a and the signal transmitted by antenna element 107b, in the case where reconfigurable antenna 100 is operating in transmit mode, and to apply phase shift ϕ between the signal received by antenna element 107b and the signal transmitted by antenna element 107a, in the case where reconfigurable antenna 100 is operating in receive mode.

FIG. 2 illustrates an example in which each elementary cell 107 is configured to introduce a phase shift ϕ between the signals received or transmitted by antenna element 107a and the signals transmitted or received by antenna element 107b. This example is however not limiting, and the elementary cell may, as a variant or as a complement, implement other functions, for example a polarization state change function enabling to pass from a signal having a left-hand circular polarization to a signal having a right-hand circular polarization. As an example, each elementary cell 107 of reconfigurable transmitarray 105 has a structure identical or similar to the elementary transmitarray cell described in patent application EP 4117117, the cell then being adapted, for example, to switching between two polarization states and four phase states.

FIG. 2 illustrates an example in which the amplification circuit 200 of elementary cell 103 comprises switch 201 enabling to enable either amplifier 203, during transmit phases, or amplifier 205, during receive phases. This example is not limiting, and the amplification circuit 200 of each elementary cell 103 of amplifier array 101 may, as a variant, be devoid of switch 201 and comprise a single amplifier, for example amplifier 203, in a case where antenna 100 is intended to be used exclusively in transmit mode, or amplifier 205, in a case where antenna 100 is intended to be used exclusively in receive mode.

FIG. 3 is a simplified and partial top view of the antenna 100 of FIG. 1 according to an embodiment. FIG. 3 more specifically illustrates a case in which the amplifier array 101 of reconfigurable antenna 100 comprises four times fewer amplification circuits 200 than antenna elements 103b.

In the shown example, each amplification circuit 200 is located substantially vertically in line with the center of a square formed by the four antenna elements 103b of the corresponding elementary cell 103. In the shown example, each amplification circuit 200 is connected to circuit 109 by radio-frequency lines 301, symbolized by segments in solid lines in FIG. 3. Although this has not been detailed in FIG. 3, power dividers may be provided at the intersections between radio frequency lines 301 to divide the power of the signal transmitted from circuit 109 to circuits 200.

For the sake of simplicity, amplification circuits 200 and antenna elements 103b have been symbolized in FIG. 3 by squares, it being understood that amplification circuits 200 and antenna elements 103b may, in practice, have any shape.

The reconfigurable antenna 100 previously described in relation with FIGS. 1 to 3 has, for example, a hybrid structure between that of a phased-array antenna and that of a transmitarray antenna. In particular, antenna 100 differs from a phased-array antenna in that amplifier array 101 is devoid of phase-shift circuits. This advantageously enables to avoid energy losses and to eliminate tedious steps of radio frequency line synchronization and calibration, enabling to couple, or to connect, each elementary antenna of the phased array to a control circuit, for example similar to circuit 109. In the case of antenna 100, phase shifts are applied by transmitarray 105, for example by using radio frequency switches.

Further, unlike transmitarray antennas which generally comprise one or a plurality of primary sources adapted to generating a beam of generally conical shape irradiating all or part of the transmitarray, each primary source comprising, for example, a horn antenna, reconfigurable antenna 100 uses as a source the amplifier array 101 irradiating transmitarray 105. This advantageously enables antenna 100 to have a thickness smaller than that which would be exhibited by an antenna with a comparable transmitarray. This further provides the advantage, as compared with a transmitarray antenna, of facilitating the forming of systems for amplifying the transmitted or received radio frequency signal.

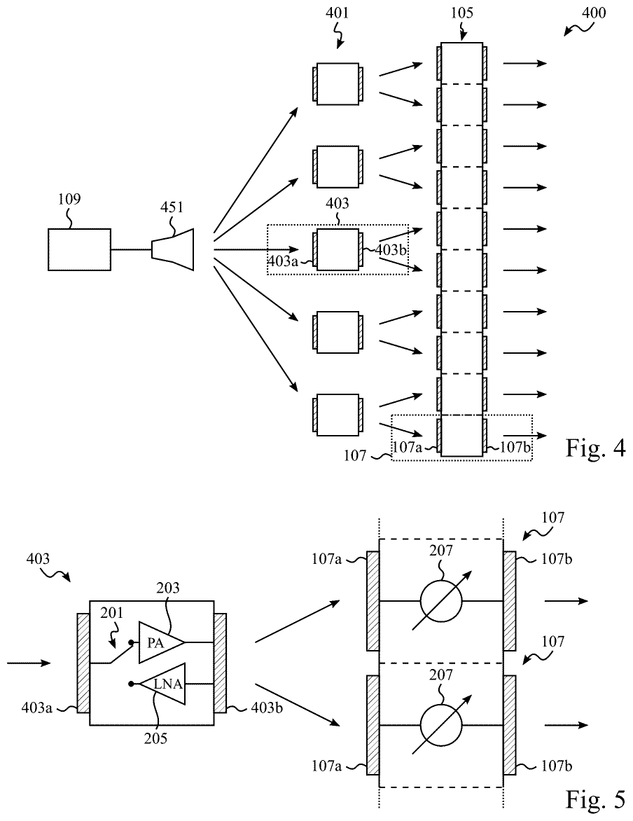

FIG. 4 is a simplified and partial side view of a reconfigurable antenna 400 according to an embodiment. The reconfigurable antenna 400 of FIG. 4 has elements in common with the reconfigurable antenna 100 of FIG. 1. These common elements will not be detailed again hereafter.

The reconfigurable antenna 400 of FIG. 4 differs from the reconfigurable antenna 100 of FIG. 1 in that antenna 400 comprises, instead of amplifier array 101, an amplifier array 401 comprising a plurality of elementary cells 403.

The elementary cells 403 of amplifier array 401 are for example arranged in an array of rows and columns. Further, the elementary cells 403 are for example substantially located in the same plane, array 401 being in this case of planar type. In the illustrated example, each elementary cell 403 comprises a first antenna element 403a located on the side of a first surface of the amplifier array 401 arranged opposite one or a plurality of primary sources 451 (a single source 451, in the shown example), and a second antenna element 403b, located on the side of a second surface of array 401 opposite to the first surface. The antenna element 403b of elementary cells 403 is, for example, identical or similar to one of the antenna elements 103b of the elementary cells 103 described hereabove. As an example, amplifier array 401 is built in planar technology, for example on a printed circuit board.

In the illustrated example, primary source 451 is connected to circuit 109. The primary source comprises, for example, a horn antenna irradiating the first surface of array 401. As an example, the central axis of each primary source is substantially orthogonal to the mean plane of array 401.

FIG. 4 more particularly illustrates a case in which reconfigurable antenna 400 operates in transmit mode. In this case, each elementary cell 403 of amplifier array 401 is capable of receiving, on its first antenna element 403a, an electromagnetic radiation originating from primary source 451, and of transmitting, from its second antenna element 403b, an electromagnetic radiation towards transmitarray 105. Each elementary cell 107 of transmitarray 105 is capable of receiving, on its first antenna element 107a, the electromagnetic radiation emitted by the elementary cells 403 of amplifier array 401, and of transmitting back this radiation from its second antenna element 107b, for example by introducing a known phase shift ¢.

Although this has not been shown, reconfigurable antenna 400 may, as a variant, operate in receive mode. In this case, each elementary cell 107 of transmitarray 105 is capable of receiving, on its second antenna element 107b, an electromagnetic radiation originating from the outer environment and of transmitting back this radiation, from its first antenna element 107a, towards amplifier array 401, with phase shift ¢. Each elementary cell 403 of amplifier array 401 is capable of receiving, on its second antenna element 403b, the electromagnetic radiation emitted by the elementary cells 107 of transmitarray 105, and of transmitting back this radiation, from its first antenna element 403a, towards source 451. The radiation transmitted back by antenna element 403a is, for example, focused on source 451.

FIG. 4 illustrates an example in which amplifier array 401 comprises a number of elementary cells 403 smaller than the number of elementary cells 107 of transmitarray 105. For example, reconfigurable antenna 400 comprises four, nine, or sixteen times fewer elementary cells 403 than elementary cells 107. However, this example is not limiting, and reconfigurable antenna 400 may as a variant comprise as many elementary cells 403 as elementary cells 107.

Further, FIG. 4 illustrates an example in which each elementary cell 403 of amplifier array 401 comprises a single first antenna element 403a and a single second antenna element 403b. However, this example is not limiting and each elementary cell 403 of amplifier array 401 may, as a variant, comprise a plurality of first antenna elements 403a and a plurality of second antenna elements 403b.

FIG. 5 is a detail view of a portion of the antenna 400 of FIG. 4. FIG. 5 more specifically shows one elementary cell 403 and two antenna elements 107 located opposite one another.

Elementary cell 403 differs, for example, from the previously-described elementary cell 103 in that, in elementary cell 403, the input of switch 201 is connected to the first antenna element 403a of elementary cell 403.

The operation of reconfigurable antenna 400, in particular the control of the switch 201 of each elementary cell 403 according to whether antenna 400 is used in transmit or in receive mode, is similar to the operation previously described in relation with FIG. 2 for reconfigurable antenna 100.

FIG. 5 illustrates an example in which elementary cell 403 comprises switch 201 enabling to enable either amplifier 203, during transmit phases, or amplifier 205, during receive phases. However, this example is not limiting, and each elementary cell 403 of array 401 may, as a variant, be devoid of switch 201 and comprise a single amplifier, for example amplifier 203, in a case where antenna 400 is used exclusively in transmit mode, or amplifier 205, in a case where antenna 400 is used exclusively in receive mode.

Reconfigurable antenna 400 provides advantages similar to those of reconfigurable antenna 100.

Various embodiments and variants have been described. Those skilled in the art will understand that certain features of these various embodiments and variants may be combined, and other variants will occur to those skilled in the art. In particular, those skilled in the art are capable of adjusting the ratio of the number of elementary cells 103, 403 of amplifier array 101, 401 to the number of elementary cells 107 of transmitarray 105 according to the application, for example according to the heating generated by each elementary cell 103, 403. Those skilled in the art are also capable of adjusting the number of antenna elements of each elementary cell 103, 403 of amplifier array 101, 401, in particular according to the proportion of elementary cells 103, 403 of amplifier array 101, 401 with respect to the elementary cells 107 of transmitarray 105.

Finally, the practical implementation of the described embodiments and variants is within the abilities of those skilled in the art based on the functional indications given hereabove. In particular, the practical forming of the antenna element(s), of the switch, and of the amplifier(s) of the elementary cells of the amplifier array, as well as the practical forming of the elementary cells of the transmitarray, are within the abilities of those skilled in the art based on the indications of the present disclosure.

Further, the elementary cells 107 of transmitarray 105 may be calibrated so as to correct phase errors linked to the antenna structure.

1. Antenna comprising:
an amplifier array comprising a plurality of first elementary cells; and
a transmitarray comprising a plurality of second elementary cells, wherein the amplifier array is configured to irradiate, or to be irradiated by, the transmitarray, the amplifier array being separated from the transmitarray by a distance equal, to within 20%, to a central transmission and/or reception wavelength of the antenna.

2. Antenna according to claim 1, wherein the distance separating the amplifier array from the transmitarray is equal, to within 10%, to the central transmission and/or reception wavelength of the antenna.

3. Antenna according to claim 1, wherein each first elementary cell comprises a first antenna element located in front of the transmitarray.

4. Antenna according to claim 3, wherein each first elementary cell further comprises at least one amplifier connected to the first antenna element.

5. Antenna according to claim 4, wherein each first elementary cell comprises:
a first amplifier, preferably a power amplifier, intended to amplify a signal transmitted by the antenna;
a second amplifier, preferably a low-noise amplifier, intended to amplify a signal received by the antenna; and
a switch configured to enable the first or the second amplifier as a function of a control signal.

6. Antenna according to claim 1, wherein each first elementary cell is connected to a radio frequency signal transceiver circuit.

7. Antenna according to claim 1, further comprising at least one source configured to irradiate, or to be irradiated by, the amplifier array.

8. Antenna according to claim 7, wherein said at least one source is connected to a radio frequency signal transceiver circuit.

9. Antenna according to claim 7, wherein each first cell further comprises a second antenna element located in front of said at least one source.

10. Antenna according to claim 7, wherein said at least one source is a single horn antenna.

11. Antenna according to claim 1, comprising fewer first elementary cells than second elementary cells, preferably four times fewer first elementary cells than second elementary cells.

12. Antenna according to claim 1, wherein each second elementary cell comprises third and fourth antenna elements coupled by a phase-shift circuit.

13. Antenna according to claim 1, wherein the amplifier array is devoid of phase-shift circuits.
